(19) United States
(12) Patent Application Publication
(10) Pub. No.: US 2026/0204834 A1
(43) Pub. Date: Jul. 16, 2026

(54) Connector

(71) Applicant: Yazaki Corporation, Tokyo (JP)

(72) Inventor: Yoshinori Ishikawa, Shizuoka (JP)

(21) Appl. No.: 19/447,272

(22) Filed: Jan. 13, 2026

(30) Foreign Application Priority Data
Jan. 14, 2025 (JP) 2025-004679

(51) Int. Cl. H01R 13/506; H01R 43/18

(52) U.S. Cl. CPC H01R 13/506; H01R 43/18

(57) ABSTRACT

A connector includes a housing, a lever that is rotatably assembled to an outer surface of the housing, and a cover that is assembled to the housing via an engagement portion arranged on an inner surface side of the lever, wherein the lever is provided with a jig insertion hole that communicates with the engagement portion and an outer surface of the lever, and allows insertion of a release jig thereinto, the release jig releasing engagement of the engagement portion.

### CROSS-REFERENCE TO RELATED APPLICATIONS

The present application is based on, and claims priority from the prior Japanese Patent Application No. 2025-004679, filed on January 14, 2025, the entire contents of which are incorporated herein by reference.

### TECHNICAL FIELD

The present disclosure relates to a connector.

### BACKGROUND

In the related art, there is known a connector including a housing, a lever rotatably assembled to an outer surface of the housing, and a cover assembled to the housing (see JP 2012-69306 A). In the connector, a hook portion and a hook claw that serve as an engagement portion for maintaining an assembled state between the housing and the cover are provided between the housing and the cover. The hook portion and the hook claw are arranged on an inner surface side of the lever. The engagement between the hook portion and the hook claw can be released by elastically deforming the hook claw by a release jig. By releasing the engagement between the hook portion and the hook claw, the cover can be removed from the housing.

### SUMMARY OF THE INVENTION

Incidentally, in the connector as disclosed in JP 2012-69306 A, for example, the release jig is inserted through a gap visible from above the lever into the engagement portion arranged on the inner surface side of the lever, and an operation for releasing the engagement of the engagement portion is performed. Thus, it is necessary to carefully insert the release jig so as to avoid interference between the release jig and components other than the engagement portion, and the workability in releasing the engagement of the engagement portion is degraded.

The present disclosure has been made in view of such a problem in the related art. Further, an object of the present disclosure is to provide a connector capable of improving the workability in releasing engagement of an engagement portion.

A connector according to an embodiment includes a housing, a lever that is rotatably assembled to an outer surface of the housing, and a cover that is assembled to the housing via an engagement portion arranged on an inner surface side of the lever, wherein the lever is provided with a jig insertion hole that communicates with the engagement portion and an outer surface of the lever, and allows insertion of a release jig thereinto, the release jig releasing engagement of the engagement portion.

According to the present disclosure, it is possible to provide a connector capable of improving the workability in releasing engagement of an engagement portion.

### BRIEF DESCRIPTION OF DRAWINGS

FIG. 1 is a perspective view of a connector according to the present embodiment.

FIG. 2 is a cross-sectional view of the connector according to the present embodiment.

FIG. 3 is an enlarged view of the main part in FIG. 2.

FIG. 4 is an enlarged perspective view of the main part when a release jig is inserted into a jig insertion hole of the connector according to the present embodiment.

FIG. 5 is an enlarged cross-sectional view of the main part when the release jig is inserted into the jig insertion hole of the connector according to the present embodiment.

FIG. 6 is an enlarged cross-sectional view of the main part when the release jig is inserted into the jig insertion hole of the connector according to the present embodiment to release engagement of an engagement portion.

FIG. 7 is a perspective view of a housing of the connector according to the present embodiment.

FIG. 8 is a perspective view of a lever of the connector according to the present embodiment.

FIG. 9 is a perspective view of a cover of the connector according to the present embodiment.

FIG. 10 is a perspective view of the release jig of the connector according to the present embodiment.

### DETAILED DESCRIPTION OF THE INVENTION

With reference to the drawings, a connector according to the present embodiment is described below in detail. Note that the dimensional ratios in the drawings are exaggerated for explanatory purposes, and may differ from the actual ratios.

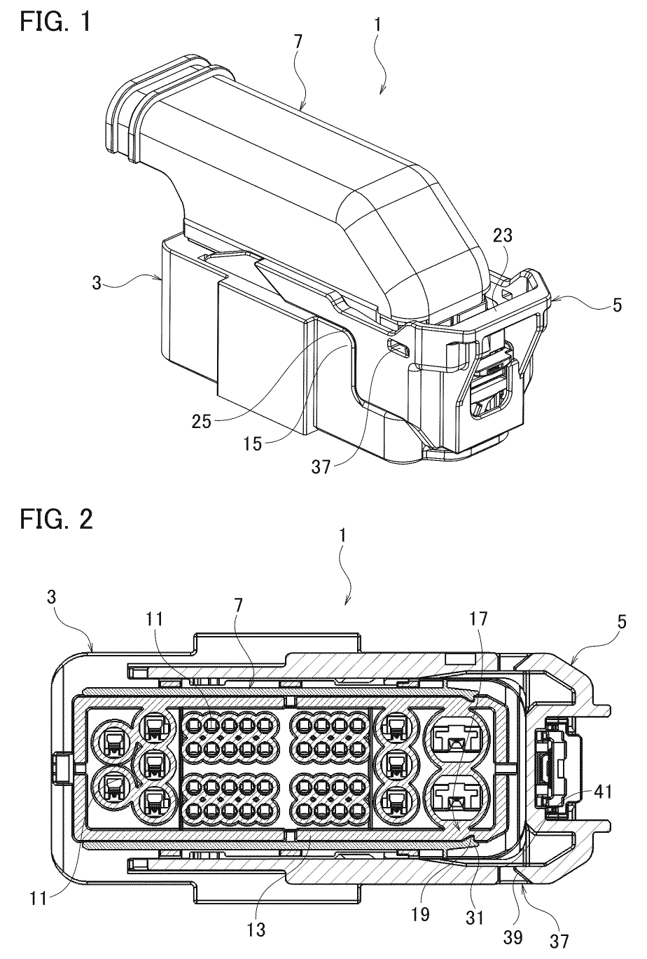

As illustrated in FIG. 1, a connector 1 according to the present embodiment electrically connects two electrical components (not illustrated) to each other, for example, between a power supply mounted on a vehicle and an apparatus, or between apparatuses. The connector 1 is electrically connected to one of the electrical components, and is fittable with a mating connector (not illustrated) that is electrically connected to the other electrical component. When the connector 1 is fitted with the mating connector, the two electrical components are electrically connected to each other.

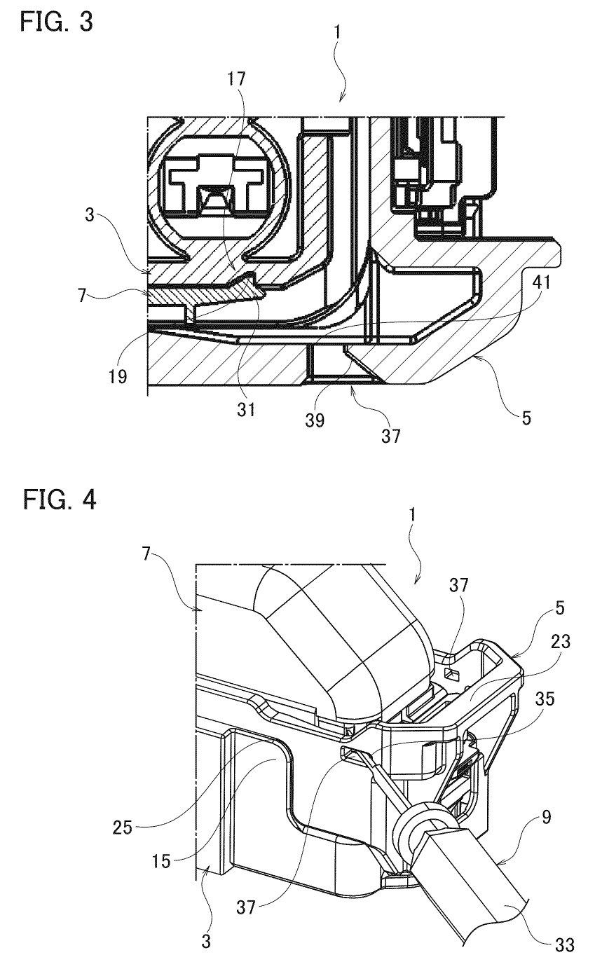

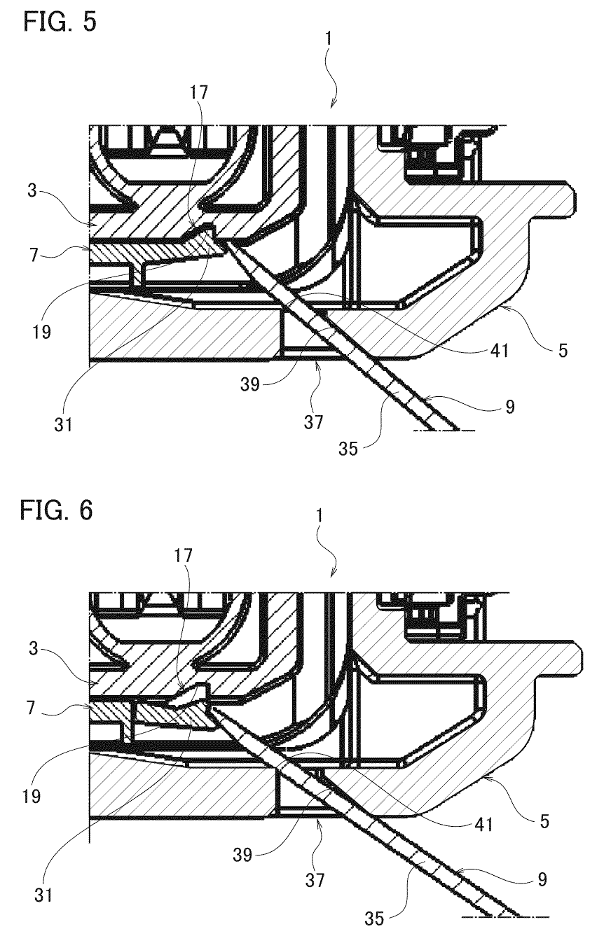

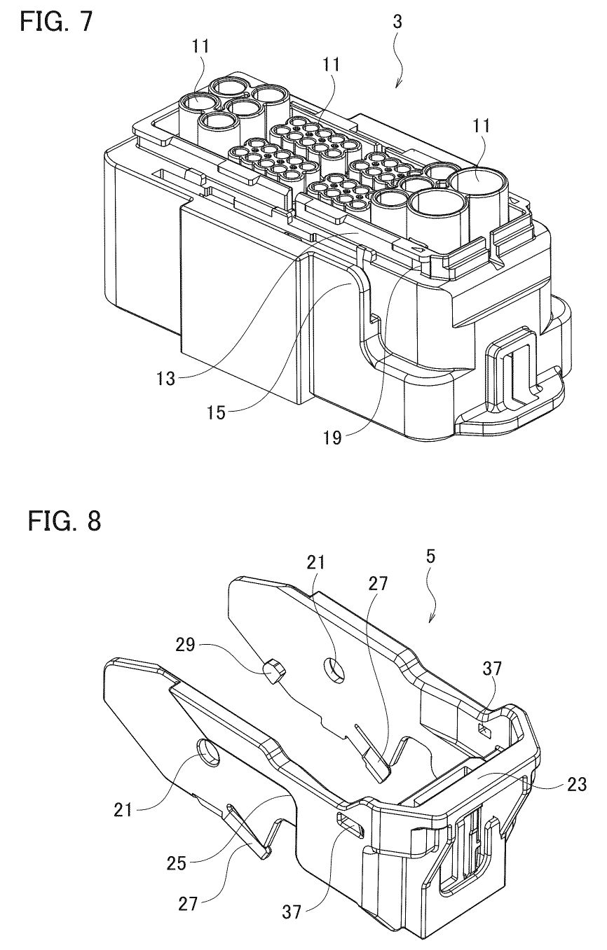

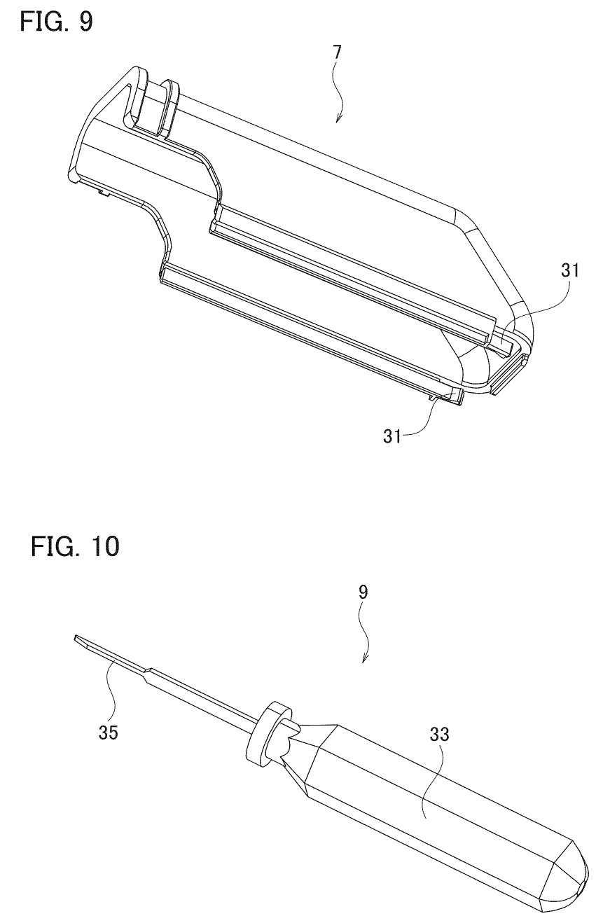

As illustrated in FIG. 1 to FIG. 10, the connector 1 includes a housing 3, a terminal (not illustrated), a lever 5, a cover 7, and a release jig 9.

As illustrated in FIG. 1 to FIG. 7, the housing 3 is formed of an electrical insulating material such as a synthetic resin. The housing 3 is formed into a casing shape in which a mating housing of a mating connector (not illustrated) can be fitted. Inside the housing 3, a plurality of terminal accommodation chambers 11 are provided. The terminal accommodation chamber 11 extends along a fitting direction with the mating housing. Both ends of the terminal accommodation chamber 11 in a length direction are opened. One opening of the terminal accommodation chamber 11 serves as a connection opening into which a mating terminal of the mating connector (not illustrated) is inserted when the housing 3 and the mating housing are fitted with each other. The other opening of the terminal accommodation chamber 11 serves as an insertion opening through which a terminal can be inserted into the inside. Inside the terminal accommodation chamber 11, a locking lance that is engaged with the terminal is provided in an elastically deformable manner.

The plurality of terminal accommodation chambers 11 are collectively arranged in a tubular fitting portion 13 that is arranged apart from an inner surface of an outer peripheral wall of the housing 3. On the connection opening side of the terminal accommodation chamber 11, a space between an outer surface of the fitting portion 13 positioned inside the housing 3 and the inner surface of the outer peripheral wall of the housing 3 serves as an accommodation space in which the mating housing and the lever 5 can be accommodated. Shaft portions (not illustrated) extend inward respectively from inner surfaces of outer peripheral walls of the housing 3 that are positioned on both sides in a width direction. Completion holding portions that hold the lever 5 at a rotation completion position are provided respectively inside the outer peripheral walls of the housing 3 that are positioned on both the sides in the width direction. Start holding portions 15 that hold the lever 5 at a rotation start position are provided respectively outside the outer peripheral walls of the housing 3 on both the sides in the width direction. On the insertion opening side of the terminal accommodation chamber 11, locked portions 19 that constitute engagement portions 17 recessed inward from the outer surfaces are provided respectively on both the sides of the fitting portion 13 in the width direction that are exposed from the housing 3.

Although omitted in illustration, a plurality of terminals formed of an electroconductive material are used. The terminal is electrically connected, for example, to a terminal end of an electric wire (not illustrated) that is electrically connected to one of the electrical components, by crimping or the like. The terminal is accommodated in the terminal accommodation chamber through the insertion opening of the terminal accommodation chamber 11, and is engaged with the locking lance of the terminal accommodation chamber 11. Due to the engagement between the terminal and the locking lance, the terminal is restricted from coming off from the insertion opening of the terminal accommodation chamber 11, and the terminal can be held in the housing 3. The terminal accommodated in the terminal accommodation chamber 11 is in a state in which the electric wire is drawn from the insertion opening of the terminal accommodation chamber 11 to the outside of the housing 3. When the housing 3 and the mating housing are fitted with each other, the terminal is electrically connected to the mating terminal.

As illustrated in FIG. 1 to FIG. 6 and FIG. 8, the lever 5 is formed of an electrical insulating material such as a synthetic resin. The lever 5 is formed into a U-like shape so as to cover the outer surface of the fitting portion 13 of the housing 3 with a pair of side walls and a coupling wall that couples the pair of side walls. Shaft holes 21 that are formed to pass through the side walls are provided respectively on the pair of side walls of the lever 5. The shaft portion of the housing 3 is inserted into the shaft hole 21, and the lever 5 is rotatably assembled to the housing 3. The coupling wall of the lever 5 is provided with an operation portion 23 that rotates the lever 5. Start engagement portions 25 are provided respectively on outer surfaces of the pair of side walls of the lever 5. The start engagement portion 25 is engaged with the start holding portion 15 of the housing 3 when the lever 5 is at the rotation start position (see FIG. 1). Due to the engagement between the start engagement portion 25 and the start holding portion 15, the lever 5 can be held at the rotation start position. On the pair of side walls of the lever 5, completion engagement pieces 27 each including a protrusion formed on a free end side are provided in an elastically deformable manner. The completion engagement piece 27 is engaged with a completion holding portion of the housing 3 when the lever 5 is at the rotation completion position (not illustrated). Due to the engagement between the completion engagement piece 27 and the completion holding portion, the lever 5 can be held at the rotation completion position.

On the inner surfaces of the pair of side walls of the lever 5, cam pins 29 protruding inward from the inner surfaces are provided. The cam pin 29 is arranged on the fitting surface side of the fitting portion 13 when the lever 5 is at the rotation start position. When the housing 3 and the mating housing are fitted with each other, the cam pin 29 is arranged in a cam groove (not illustrated) provided in the mating housing. The cam pin 29 arranged in the cam groove is fitted so that the cam pin 29 moves along the cam groove by rotation of the lever 5 and the mating housing is drawn into the housing 3. By providing the housing 3 with the lever 5, a force required for an operation of fitting the housing 3 and the mating housing with each other can be reduced, and assemblability can be improved.

As illustrated in FIG. 1 to FIG. 6 and FIG. 9, the cover 7 is formed of an insulating material such as a synthetic resin. The cover 7 is formed into an L-like shape so as to cover the outer peripheries of the plurality of electric wires drawn from the insertion opening of the plurality of terminal accommodation chambers 11 and restricts the drawing direction of the plurality of electric wires. On the housing 3 side of both sides in a width direction of the cover 7, locking pieces 31 that constitute the engagement portions 17 and each include a protrusion formed on a free end side are provided in an elastically deformable manner. When the cover 7 is assembled to the housing 3, the protrusion of the locking piece 31 is arranged on the operation portion 23 side of the lever 5 with respect to the outer surface of the fitting portion 13. By moving the cover 7 to the side opposite to the operation portion 23 of the lever 5 with respect to the housing 3, the protrusion slides with the outer surface of the fitting portion 13, and the locking piece 31 is elastically deformed. When the cover 7 is arranged at a regular position with respect to the housing 3, the locking piece 31 that is elastically deformed is restored, and the protrusion is engaged with the locked portion 19. Due to the engagement between the locked portion 19 and the locking piece 31 in the engagement portion 17, movement in the direction in which the cover 7 is separated away from the housing 3 (the upward direction in FIG. 1) and movement to the operation portion 23 side of the lever 5 are restricted, and the assembly state of the cover 7 with respect to the housing 3 can be maintained. Note that movement of the cover 7 to the side opposite to the operation portion 23 of the lever 5 is restricted when the outer surface of the fitting portion 13 and the inner surface of the cover 7 abut against each other. The engagement portion 17 is arranged on the inner surface side of the lever 5 when the lever 5 is at the rotation start position, and is arranged to overlap with the lever 5 as the connector 1 is viewed from the side.

As illustrated in FIG. 4 to FIG. 6 and FIG. 10, the release jig 9 includes a grip portion 33 and a release portion 35. The grip portion 33 is formed into a polygonal shaft-like shape, and serves as an operation portion that is gripped by an operator to operate the release jig 9. The release portion 35 extends from one side of the grip portion 33 along a length direction of the grip portion 33, and is formed into a rectangular shaft-like shape thinner than the grip portion 33. The distal end of the release portion 35 is inclined so that the thickness thereof is reduced toward the distal end side, and hence can be engaged with the distal end of the locking piece 31. When the release portion 35 is engaged with the locking piece 31, and the grip portion 33 is operated, the release jig 9 elastically deforms the locking piece 31. When the locking piece 31 is elastically deformed, the engagement between the locked portion 19 and the locking piece 31 is released, and the cover 7 can be removed from the housing 3.

Here, in a connector in the related art, for example, when the release jig 9 releases the engagement of the engagement portion 17, the release portion 35 is inserted through a gap visible from above the lever 5, the release portion 35 is engaged with the locking piece 31, and the locking piece 31 is elastically deformed. Thus, in the connector in the related art, it is necessary to carefully insert the release portion 35 so as to avoid interference between the release portion 35 and components other than the locking piece 31, and the workability in releasing the engagement of the engagement portion 17 is degraded. In view of this, the lever 5 is provided with a jig insertion hole 37 that allows insertion of the release portion 35 of the release jig 9 thereinto.

As illustrated in FIG. 1 to FIG. 6 and FIG. 8, the jig insertion holes 37 are provided respectively in the pair of side walls of the lever 5 so as to correspond to the engagement portions 17. The jig insertion hole 37 is formed to pass through the side wall of the lever 5 so that the inner surface and the outer surface of the side wall of the lever 5 communicate with each other. When the lever 5 is at the rotation start position, the jig insertion hole 37 is arranged at a position at which the engagement portion 17 is visible through the opening on the inner surface side of the lever 5 as viewed from the opening on the outer surface side of the lever 5. Thus, by inserting the release portion 35 of the release jig 9 into the jig insertion hole 37, the release portion 35 can be engaged with the locking piece 31 without interference between the release portion 35 and components other than the engagement portion 17, and the engagement of the engagement portion 17 can be released. Therefore, there is no need to carefully insert the release portion 35 at the time of releasing the engagement of the engagement portion 17, and the workability in releasing the engagement of the engagement portion 17 can be improved.

The jig insertion hole 37 is provided with a guide portion 39 and a restricting portion 41. The guide portion 39 is arranged inside the jig insertion hole 37, extends between an opening edge on the inner surface side of the lever 5 and an opening edge on the outer surface side of the lever 5, and forms an inclination surface that is inclined to widen the opening on the outer surface side of the lever 5. The guide portion 39 slides with release portion 35 of the release jig 9 inserted into the jig insertion hole 37, and thus guides the distal end of the release portion 35 to the distal end of the locking piece 31 of the engagement portion 17. By providing the guide portion 39 in the jig insertion hole 37, the release portion 35 can be guided easily to the engagement portion 17, and the workability in releasing the engagement of the engagement portion 17 can be improved. Note that the opening edge of the guide portion 39 on the outer surface side of the lever 5 serves as a support point for elastically deforming the locking piece 31 by the release portion 35, and thus the engagement of the engagement portion 17 can be released easily. The restricting portion 41 is provided at the opening edge of the jig insertion hole 37 on the inner surface side of the lever 5, the opening edge facing the guide portion 39. When the release portion 35 of the release jig 9 is to elastically deform the locking piece 31 and to be operated excessively, the restricting portion 41 abuts against the release portion 35 to restrict a further operation of the release portion 35. By restricting an excessive operation of the release jig 9 by the restricting portion 41, it is possible to prevent the locking piece 31 from being excessively elastically deformed and from being damaged or deformed. Thus, the engagement of the engagement portion 17 can be maintained stably without performing an excessive engagement releasing operation in the engagement portion 17.

In the connector 1 described above, when the cover 7 is to be removed, first, the lever 5 is arranged at the rotation start position, and the release portion 35 of the release jig 9 is inserted into the jig insertion hole 37. In this state, the guide portion 39 of the jig insertion hole 37 guides the distal end of the release portion 35 to the distal end of the locking piece 31 of the engagement portion 17 to achieve the engagement therebetween. Subsequently, the release portion 35 is operated, and the release portion 35 elastically deforms the locking piece 31 to release the engagement of the engagement portion 17. In this state, the release portion 35 abuts against the restricting portion 41, and thus an excessive operation of the release portion 35 is restricted. Then, the cover 7 is removed from the housing 3, and the operation is completed.

The connector 1 described above includes the housing 3, the lever 5 that is rotatably assembled to the outer surface of the housing 3, and the cover 7 that is assembled to the housing 3 via the engagement portion 17 arranged on the inner surface side of the lever 5. Further, the lever 5 is provided with the jig insertion hole 37 that communicates with the engagement portion 17 and the outer surface of the lever 5, and allows insertion of the release jig 9 thereinto, the release jig 9 releasing the engagement of the engagement portion 17.

By inserting the release jig 9 into the jig insertion hole 37, the release jig 9 can be engaged with the engagement portion 17 without interference between the release jig 9 and components other than the engagement portion 17, and the engagement of the engagement portion 17 can be released. Thus, there is no need to carefully insert the release jig 9 when releasing the engagement of the engagement portion 17, and the workability in releasing the engagement of the engagement portion 17 can be improved.

Therefore, in the connector 1 as described above, the workability in releasing the engagement of the engagement portion 17 can be improved.

Further, the jig insertion hole 37 is provided with the guide portion 39 that guides the release jig 9 to the engagement portion 17.

Thus, the release jig 9 can be guided easily to the engagement portion 17, and hence the workability in releasing the engagement of the engagement portion 17 can be improved.

Further, the jig insertion hole 37 is provided with the restricting portion 41 that restricts an excessive operation of the release jig 9 with respect to the engagement portion 17.

Thus, damage or deformation of the engagement portion 17 due to an excessive engagement releasing operation of the release jig 9 can be prevented, and the engagement of the engagement portion 17 can be maintained stably.

While the present embodiment is described above, the present embodiment is not limited thereto, and various modifications can be made within the gist of the present embodiment.

For example, in the engagement portion, the locked portion is provided to the housing, and the locking piece is provided to the cover. However, the present embodiment is not limited thereto, and the locked portion may be provided to the cover, and the locking piece may be provided to the housing. In addition, for example, the engagement portion may have any form, such as one in which a locking protrusion and an elastically deformable locking piece formed in a frame shape are engaged with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector comprising:
a housing;
a lever that is rotatably assembled to an outer surface of the housing; and
a cover that is assembled to the housing via an engagement portion arranged on an inner surface side of the lever, wherein
the lever is provided with a jig insertion hole that communicates with the engagement portion and an outer surface of the lever, and allows insertion of a release jig thereinto, the release jig releasing engagement of the engagement portion.

2. The connector according to claim 1, wherein
the jig insertion hole is provided with a guide portion that guides the release jig to the engagement portion.

3. The connector according to claim 1, wherein
the jig insertion hole is provided with a restricting portion that restricts an excessive operation of the release jig with respect to the engagement portion.
